(19) United States
(12) Patent Application Publication
(10) Pub. No.: US 2020/0008617 A1
(43) Pub. Date: Jan. 9, 2020

(54) Rapid-Assembled Luxurious Barbecue Stove Using Charcoal

(71) Applicant: Guangdong Dehe Technology Co., Ltd., Heshan City (CN)

(72) Inventor: Youming LIANG, Heshan City (CN)

(21) Appl. No.: 16/166,605

(22) Filed: Oct. 22, 2018

(30) Foreign Application Priority Data
Jul. 5, 2018 (CN) 201810728000.1

(51) Int. Cl. A47J 37/07

(52) U.S. Cl. CPC A47J 37/07

(57) ABSTRACT

The invention relates to the field of barbecue stove and discloses a rapid-assembled luxurious barbecue stove using charcoal, comprising a back plate of the furnace body, a left plate and a right plate of the furnace body, and a front plate of the furnace body, which are encircled into a circle in sequence to form a carbon disk chamber, two ends of the back plate of the furnace body are respectively fixed to the left plate of the furnace body and the right plate of the furnace body, and the left plate and the right plate of the furnace body are perpendicular and fixed to the front plate of the furnace body; the rapid assembly of the invention substantially adopts connection such as a hook, and requires a small number of screw connections. Now, it takes about 15 minutes to assemble one, so the installation time is saved, the manpower is saved, the work efficiency is improved, and the hob made of a specific material retains the heat therein, and the maximum utilization of energy is achieved.

### CROSS-REFERENCE TO RELATED APPLICATIONS

This application claims priority to Chinese Patent Application No. 201810728000.1 filed Jul. 5, 2018, which is incorporated by reference herein in its entirety.

### BACKGROUND

This disclosure relates generally to the field of barbecue stove, in particular pertains to a rapid-assembled luxurious barbecue stove using charcoal.

### RELATED ART

Charcoal is commonly found in large-scale self-service rotisserie, Japanese-style rotisserie, Korean restaurant, northeastern Chinese rotisserie, and private room in star-rated hotel. The charcoal grill is a stove that uses machine-made smokeless charcoal as a raw material for barbecue.

In recent years, with the rapid development of science and technology, new technologies, and the improvement of the living standards of Chinese residents, the consumption of barbecue has shown a rapid increasing momentum, and gradually turned into household consumption, which is more and more popular among consumers.

At present, the domestic barbecue stove market is relatively chaotic, and there are many types of equipment. The existing barbecue stoves using charcoal are packaged in bulk when they are exported. After the customers buy the stoves, they need to assemble the stoves themselves for use. In the process of assembly, it wastes customers a large amount of time. The conventional stove adopts a large number of traditional screw connections, and thus it takes about 45 minutes, meaning that the operation is more complicated.

### SUMMARY OF THE INVENTION

The technical problem to be solved by the present invention is to overcome the existing drawbacks and to provide a rapid-assembled luxurious barbecue stove using charcoal. Currently, the rapid assembly substantially adopts connections such as hooks and the like, and requires a small number of screw connections, and now only needs to assemble one for about 15 minutes, which greatly saves assembly time, manpower, and improves work efficiency. The hob made of specific materials retains the heat, and the maximum utilization of energy is achieved, which can effectively solve the problems mentioned in the background art.

In order to solve the above technical problem, the present invention provides the following technical solutions.

The invention provides a rapid-assembled luxurious barbecue stove using charcoal, comprising a back plate, a left plate and a right plate, and a front plate of a furnace body, which are encircled into a circle in sequence to form a carbon disk chamber, two ends of the back plate of the furnace body are respectively fixed to the left plate and the right plate of the furnace body, and the left plate and the right plate of the furnace body are perpendicular and fixed to the front plate of the furnace body; bottoms of the right plate and the front plate of the furnace body are respectively fixed to one ends of a right front foot and a right rear foot, and bottoms of the back plate and the left plate of the furnace body are respectively fixed to a left rear foot and a left front foot, foot plugs are fixed to bottoms of the left rear foot and the left front foot, and one ends of axles rotatably connected with plastic wheel(s), extends through bottoms of the right front foot and the right rear foot; further comprising a bottom shelf in a rectangular parallelepiped structure, and four corners of the bottom shelf are fixed to the left rear foot, the left front foot, the right front foot and the right rear foot respectively; further comprising a carbon disk handle and a carbon disk, wherein the carbon disk is installed inside the carbon disk chamber, an upper part of the front plate of the furnace body is provided with through-hole(s), and one end of the carbon disk handle extends through the through-hole(s) and is connected to the carbon disk; further comprising a side boss assembly fixed to one side of the right front foot and the right rear foot; further comprising an upper cover assembly, wherein an upper part of the upper cover assembly is fixed with a handle seat, and an upper part of the handle seat is mounted with an upper cover handle; and further comprising a thermal insulation net and a grilling net, the grilling net is arranged on an upper part of the carbon disk, and an upper part of the grilling net is provided with the thermal insulation net.

In some embodiments, the back plate and the front plate of the furnace body are parallel to each other, and the left plate and the right plate of the furnace body are parallel to each other.

In some embodiments, a wheel cover is fixed to an outer side of the plastic wheel(s).

In some embodiments, further comprising a carbon door handle is, and an upper portion of the carbon door handle is configured for mounting with a carbon door locking piece.

In some embodiments, the upper portion of the carbon door handle is provided with a carbon door handle decorative ring.

In some embodiments, further comprising a frame handle fixed to one side of the left plate of the furnace body.

In some embodiments, further comprising a cinder disk slidably connected to a bottom of the carbon disk chamber, and a cinder disk handle is fixed at one end of the cinder disk.

The beneficial effects achieved by the present invention are that, the current rapid assembly substantially adopts connections such as hooks and the like, and requires a small number of screw connections. Now, it takes about 15 minutes to assemble one, which greatly saves assembly time, manpower, and improves work efficiency, the hob made of a specific material retains the heat therein, and the maximum utilization of energy is achieved.

### BRIEF DESCRIPTION OF THE DRAWINGS

The drawings are provided for the purpose of a further comprehension of the invention, and are intended to be a part of the description of the invention.

In the drawings:

FIG. 1 is an exploded view of a rapid-assembled luxurious barbecue stove using charcoal according to an embodiment of the present invention;

FIG. 2 is a schematic view showing charcoal tray installation of a rapid-assembled luxurious stove using charcoal according to an embodiment of the present invention; and

FIG. 3 is a schematic view of a quick-assembled luxury charcoal barbecue stove with an upper cover assembly according to an embodiment of the present invention;

Reference Numeral: 1—the back plate of the furnace body; 2—the left plate of the furnace body; 3 the right plate of the furnace body; 4—the front plate of the furnace body; 5—the left front foot; 6—the left rear foot; 7—the foot plug; 8—right front foot; 9—right rear foot; 10—axle; 11—plastic wheel; 12—wheel cover; 13—bottom shelf; 14—carbon disk handle; 15—carbon disk; 16—carbon door handle; 17—carbon door locking piece; 18—carbon door handle decorative ring; 19—frame handle; 20—side boss assembly; 21—upper cover assembly; 22—upper cover handle; 23—handle seat; 24—cinder disk; 25—cinder disk handle; 26—thermal insulation net; 27—grilling net.

### DETAILED DESCRIPTION

The preferred embodiments of the present invention are described in conjunction with the accompanying drawings, and are illustrative and explanatory of the invention.

### Embodiment 1

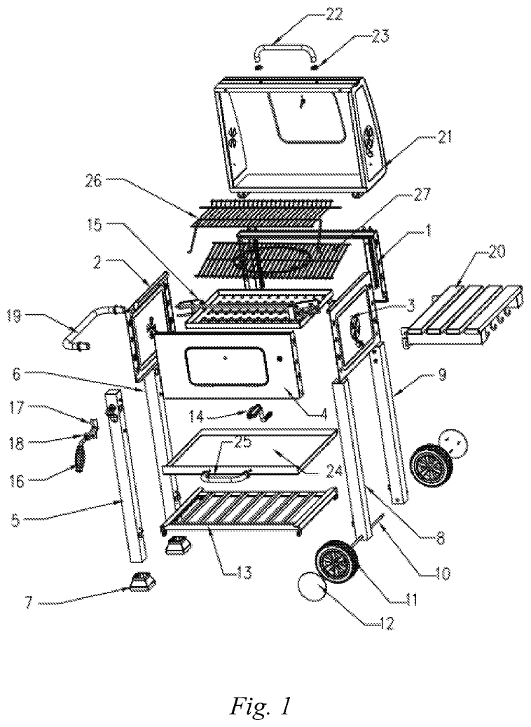

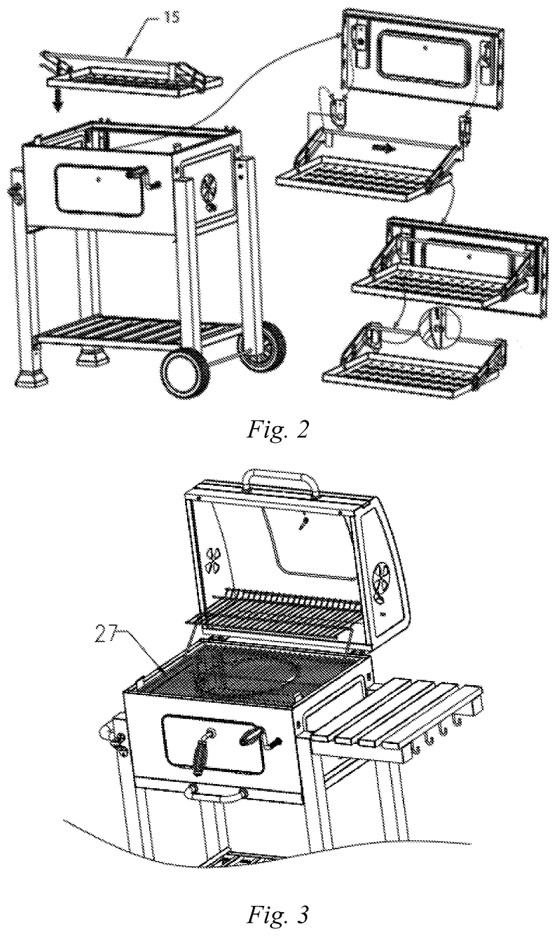

Referring to FIGS. 1-3, a rapid-assembled luxurious barbecue stove using charcoal comprises a back plate 1 of a furnace body, a left plate 2 of the furnace body, a right plate 3 of the furnace body and a front plate 4 of the furnace body, wherein the back plate 1 of the furnace body, the left plate 2 and the right plate 3 of the furnace body, and the front plate 4 of the furnace body are encircled into a circle in sequence to form a carbon disk chamber, and two ends of the back plate 1 of the furnace body are respectively fixed to the left plate 2 and the right plate 3 of the furnace body, and the left plate 2 and the right plate 3 of the furnace body are vertically fixed to the front plate 4 of the furnace body; bottoms of the right plate 3 and the front plate 4 of the furnace body are respectively fixed to one ends of a right front foot 8 and a right rear foot 9, and bottoms of the back plate 1 and the left plate 2 of the furnace body are respectively fixed to a left rear foot 6 and a left front foot 5, foot plugs 7 are fixed to bottoms of the left rear foot 6 and the left front foot 5, and one ends of the axles 10 rotatably connected with plastic wheel(s) 11, extends through bottoms of the right front foot 8 and the right rear foot 9; further comprises a bottom shelf 13 in a rectangular parallelepiped structure, and four corners of the bottom shelf 13 are fixed to the left rear foot 6, the left front foot 5, the right front foot 8 and the right rear foot 9 respectively; further comprises a carbon disk handle 14 and a carbon disk 15, wherein the carbon disk 15 is installed inside the carbon disk chamber, an upper part of the front plate of the furnace body 4 is provided with through-hole(s), and one end of the carbon disk handle 14 extends through the through-hole(s) and is connected to the carbon disk 15; further comprises a side boss assembly 20 fixed to one side of the right front foot 8 and the right rear foot 9; further comprises an upper cover assembly 21, wherein an upper part of the upper cover assembly 21 is fixed with a handle seat 23, and an upper part of the handle seat 23 is mounted with an upper cover handle 22; and further comprises a thermal insulation net 26 and a grilling net 27, the grilling net 27 is arranged on an upper part of the carbon disk 15, and an upper part of the grilling net 27 is provided with the thermal insulation net 26.

Further, the back plate 1 and the front plate 4 of the furnace body are parallel to each other, and the left plate 2 and the right plate 3 of the furnace body are parallel to each other.

Further, a wheel cover 11 is fixed to an outer side of the plastic wheel(s) 12.

Further, a carbon door handle 16 is included, and an upper portion of the carbon door handle 16 is configured for mounting with a carbon door locking piece 17.

Further, the upper portion of the carbon door handle 16 is provided with a carbon door handle decorative ring 18.

Further, a frame handle 19 is included, and the frame handle 19 is fixed to one side of the left plate 2 of the furnace body.

Further comprises a cinder disk 24 slidably connected to a bottom of the carbon disk chamber is further included, and the cinder disk handle 25 is fixed at one end of the gray disk 24.

It should be noted that the present invention is a rapid-assembled luxurious barbecue stove using charcoal. When in use, the upper cover assembly 21 is opened, and the grilling net 27 is taken out; 2-3 pieces of solid ignition fuels are placed in the middle of the carbon tray; at most 1.35 kg of charcoal is placed to surround the fuel; before the barbecue, the stove is preheated for at least 1-2 hours; when the charcoal is getting hotter, a long handle tool is used to spread the charcoal; the grill is placed in position, the charcoal is adjusted to the appropriate height with the lift; When covered with cinder, meat is placed on the grilling net; after the meat is cooked, it can be placed on the side boss with a plate; other barbecue tools can be hung on the side hook; the top is kept open or the top cover is closed, depending on different meat; if it requires a long time to roast, the upper cover is kept closed as appropriate; the upper cover thermometer shows the grilling temperature; it should be confirmed that the grilling temperature is not too high, otherwise meat will be burnt; barbecue temperature is adjusted with the hood and the damper on the furnace body; the invention has the advantages of simple structure, convenient installation, convenient use, saving manpower and improving work efficiency, and the stove frame made of a specific material retains the heat therein. the use of energy is maximized.

It should be noted that, the above description is only preferred embodiments of the present invention and is not intended to limit the present invention, although the present invention has been described in detail with reference to the foregoing embodiments. Modifications or equivalent substitutions may be made to the technical solutions described in the foregoing embodiments by the one skilled in the art. Any modifications, equivalent substitutions, improvements, etc. made within the spirit and scope of the present invention are intended to be included within the scope of the present invention.

What is claimed is:

1. A rapid-assembled luxurious barbecue stove using charcoal, comprising aback plate of a furnace body, a left plate of the furnace body, a right plate of the furnace body and a front plate of the furnace body 4, wherein
the back plate, the left plate, the right plate and the front plate are encircled into a circle in sequence to form carbon disk chamber, two ends of the back plate of the furnace body are respectively fixed to the left plate and the right plate of the furnace body, and the left plate and the right plate of the furnace body are perpendicular and fixed to the front plate of the furnace body;
bottoms of the right plate and the front plate of the furnace body are respectively fixed to one ends of a right front foot and a right rear foot, and bottoms of the back plate and the left plate of the furnace body are respectively fixed to a left rear foot and a left front foot, foot plugs are fixed to bottoms of the left rear foot and the left front foot, and one ends of axles rotatably connected t the plastic wheel(s), extend through bottoms of the right front foot and the right rear foot;
further comprising a bottom shelf in a rectangular parallelepiped structure, and four corners of the bottom shelf are fixed to the left rear foot, the left front foot, the right front foot and the right rear foot respectively;
further comprising a carbon disk handle and a carbon disk, wherein the carbon disk is installed inside the carbon disk chamber, an upper part of the front plate of the furnace body is provided with through-hole(s), and one end of the carbon disk handle extends through the through-hole(s) and is connected to the carbon disk;
further comprising a side boss assembly fixed to one side of the right front foot and the right rear foot;
further comprising an upper cover assembly, wherein an upper part of the upper cover assembly is fixed with a handle seat, and an upper part of the handle seat is mounted with an upper cover handle; and
further comprising a thermal insulation net and a grilling net, the grilling net is arranged on an upper part of the carbon disk, and an upper part of the grilling net is provided with the thermal insulation net.

2. The rapid-assembled luxurious barbecue stove of claim 1, wherein the back plate and the front plate of the furnace body are parallel to each other, and the left plate and the right plate of the furnace body are parallel to each other.

3. The rapid-assembled luxurious barbecue stove of claim 1, wherein a wheel cover is fixed to an outer side of plastic wheel(s).

4. The rapid-assembled luxurious barbecue stove of claim 1, further comprising a carbon door handle, and an upper portion of the carbon door handle is configured for mounting with a carbon door locking piece.

5. The rapid-assembled luxurious barbecue stove of claim 4, wherein the upper portion of the carbon door handle is provided with a carbon door handle decorative ring.

6. The rapid-assembled luxurious barbecue stove of claim 1, further comprising a frame handle fixed to one side of the left plate of the furnace body.

7. The rapid-assembled luxurious barbecue stove of claim 1, further comprising a cinder disk slidably connected to a bottom of the carbon disk chamber, and a cinder disk handle is fixed at one end of the cinder disk.
